(19) United States
(12) Patent Application Publication
(10) Pub. No.: US 2019/0147266 A1
(43) Pub. Date: May 16, 2019

(54) DISTRACTED DRIVING DETERMINATION APPARATUS, DRIVING SUPPORT SYSTEM, DISTRACTED DRIVING DETERMINATION METHOD, AND PROGRAM FOR DISTRACTED DRIVING DETERMINATION

(71) Applicant: OMRON Corporation, Kyoto-shi (JP)

(72) Inventors: Tomoyoshi AIZAWA, Kyoto-shi (JP); Tadashi HYUGA, Hirakata-shi (JP); Hatsumi AOI, Kyotanabe-shi (JP); Yoshio MATSUURA, Kasugai-shi (JP); Masato TANAKA, Kizugawa-shi (JP); Keisuke YOKOTA, Kasugai-shi (JP); Hisashi SAITO, Kasugai-shi (JP)

(73) Assignee: OMRON Corporation, Kyoto-shi (JP)

(21) Appl. No.: 16/143,452

(22) Filed: Sep. 27, 2018

(30) Foreign Application Priority Data
Nov. 15, 2017 (JP) 2017-219838

(51) Int. Cl. G06K 9/00; G06T 7/73; B60K 35/00; B60K 28/06; B60W 50/14

(52) U.S. Cl. CPC G06K 9/00845; G06K 9/00604; G06T 7/75; G06T 2207/30201; B60K 28/06; B60W 50/14; G06T 2207/10021; B60K 35/00

(57) ABSTRACT

The accuracy is improved for distracted driving determination performed when the vehicle changes the traveling direction. A distracted driving determination apparatus includes a first obtaining unit that obtains first information indicating a gaze or a face orientation of a driver, a second obtaining unit that obtains second information indicating an operational state of a direction indicator, and a determiner that determines distracted driving by comparing the gaze or the face orientation indicated by the first information with a predetermined criterion indicating a direction or a duration that varies depending on the operational state indicated by the second information.

### CROSS-REFERENCE TO RELATED APPLICATION

This application claims priority to Japanese Patent Application No. 2017-219838 filed on Nov. 15, 2017, the entire disclosure of which is incorporated herein by reference.

### FIELD

The present invention relates to a distracted driving determination apparatus that determines distracted driving of a vehicle driver, a driving support system, a distracted driving determination method, and a program for distracted driving determination.

### BACKGROUND

Techniques have been developed to determine distracted driving of a driver by capturing an image of the face of the driver and determining his or her face orientation with an image processor, as one such example is described in Patent Literature 1. The technique described in Patent Literature 1 changes the detection sensitivity of distracted driving depending on the vehicle state.

### CITATION LIST

### Patent Literature

Patent Literature 1: Japanese Unexamined Patent Application Publication No. 2001-138767

### SUMMARY

### Technical Problem

The gaze direction of the driver changes typically depending on the traveling direction of the vehicle. For example, the action of the driver looking in a lateral direction can be distracted driving when the vehicle is traveling straight, but may not be distracted driving and may rather be an intended gaze when the vehicle is changing the traveling direction.

However, Patent Literature 1 does not describe changing criteria used for distracted driving determination depending on the traveling direction of the vehicle.

In response to the above issue, one or more aspects of the present invention are directed to a technique that improves the accuracy of distracted driving determination performed when the vehicle changes the traveling direction.

### Solution to Problem

A distracted driving determination apparatus according to a first aspect of the disclosure includes a first obtaining unit that obtains first information indicating a gaze or a face orientation of a driver, a second obtaining unit that obtains second information indicating an operational state of a direction indicator, and a determiner that determines distracted driving by comparing the gaze or the face orientation indicated by the first information with a predetermined criterion indicating a direction or a duration that varies depending on the operational state indicated by the second information.

The distracted driving determination apparatus according to the first aspect improves the accuracy of distracted driving determination performed when the vehicle changes the traveling direction as described below. For example, when the driver intends to operate the direction indicator to turn right or left, change the lane, or be pulled over to the side of a road, the driver is likely to intentionally gaze or look in a direction different from the straight traveling direction. The distracted driving determination apparatus lowers the likelihood that such actions of the driver are erroneously determined to be distracted driving, and thus improves the accuracy of distracted driving determination.

A distracted driving determination apparatus according to a second aspect of the disclosure is the distracted driving determination apparatus according to the first aspect further including a criterion changer that changes the predetermined criterion during an operation of the direction indicator.

The distracted driving determination apparatus according to the second aspect improves the accuracy of distracted driving determination during the operation of the direction indicator as described below. For example, the driver is likely to intentionally gaze or look in a direction different from the straight traveling direction during the operation of the direction indicator. The distracted driving determination apparatus changes the criterion for distracted driving determination to lower the likelihood that such actions of the driver are erroneously determined to be distracted driving, and thus improves the accuracy of distracted driving determination.

A distracted driving determination apparatus according to a third aspect of the disclosure is the distracted driving determination apparatus according to the second aspect in which the direction indicator includes a right direction indicator and a left direction indicator, and the criterion changer changes the predetermined criterion for a left of a vehicle during an operation of the left direction indicator and changes the predetermined criterion for a right of the vehicle during an operation of the right direction indicator.

The distracted driving determination apparatus according to the third aspect improves the accuracy of distracted driving determination during the operation of the left direction indicator or the right direction indicator as descried below. For example, the driver is likely to intentionally gaze or look in the direction indicated by the direction indicator operated intentionally by the driver. The distracted driving determination apparatus lowers the likelihood that such actions of the driver are determined to be distracted driving during the operation of the left direction indicator or the right direction indicator, and thus improves the accuracy of distracted driving determination.

A distracted driving determination apparatus according to a fourth aspect of the disclosure is the distracted driving determination apparatus according to the third aspect of the disclosure in which the determiner determines that the driver is not engaging in distracted driving when the gaze or the face orientation is within a first area that is an imaginary area ranging from the driver toward a front of the vehicle and determines that the driver is engaging in distracted driving when the gaze or the face orientation is within a second area that is an imaginary area adjacent to the first area and ranging from the driver toward a left of the vehicle for a duration longer than a first duration or within a third area that is an imaginary area adjacent to the first area and ranging from the driver toward a right of the vehicle for a duration longer than a second duration.

The distracted driving determination apparatus according to the fourth aspect defines imaginary areas in the front, right, and left of the vehicle relative to the position of the driver to determine distracted driving of the driver, and thus improves the accuracy of distracted driving determination.

A distracted driving determination apparatus according to a fifth aspect of the disclosure is the distracted driving determination apparatus according to the fourth aspect that shifts, in response to an operation start of the left direction indicator, a boundary between the first area and the second area counterclockwise as viewed from the driver from a boundary position used when the left direction indicator and the right direction indicator are not operating, or shifts, in response to an operation start of the right direction indicator, a boundary between the first area and the third area clockwise as viewed from the driver from a boundary position used when the left direction indicator and the right direction indicator are not operating.

The distracted driving determination apparatus according to the fifth aspect improves the accuracy of distracted driving determination during the operation of the left direction indicator or the right direction indicator by shifting the boundary between the areas as described below. For example, the driver is likely to intentionally gaze or look in the direction indicated by the direction indicator operated intentionally by the driver. The distracted driving determination apparatus improves the accuracy of distracted driving determination by evaluating the gaze or face orientation of the driver using the criterion corresponding to the boundary between the areas shifted during the operation of the left direction indicator or the right direction indicator.

A distracted driving determination apparatus according to a sixth aspect of the disclosure is the distracted driving determination apparatus according to the fourth aspect in which the criterion changer extends the first duration in response to an operation start of the left direction indicator or extends the second duration in response to an operation start of the right direction indicator.

The distracted driving determination apparatus according to the sixth aspect extends an allowable duration for which the gaze or face orientation of the driver is allowed to reside within a predetermined range, and improves the accuracy of distracted driving determination during the operation of the left direction indicator or the right direction indicator as described below. For example, the driver is likely to intentionally gaze or look in the direction indicated by the direction indicator operated intentionally by the driver. The distracted driving determination apparatus improves the accuracy of distracted driving determination by evaluating the gaze or face orientation of the driver using the criterion under which the allowable duration, for which the gaze or face orientation of the driver is allowed to reside within a predetermined range, has been extended during the operation of the left direction indicator or the right direction indicator.

A distracted driving determination apparatus according to a seventh aspect of the disclosure is the distracted driving determination apparatus according to any one of the third to sixth aspects further including a third obtaining unit that obtains third information indicating a traveling state of the vehicle. The criterion changer changes the predetermined criterion in response to an operation start of the left direction indicator or changes the predetermined criterion in response to an operation start of the right direction indicator during traveling of the vehicle, and disables a change of the predetermined criterion while the vehicle is stopped.

The distracted driving determination apparatus according to the seventh aspect correctly determines whether the driver is engaging in distracted driving during the operation of the left direction indicator or the right direction indicator when the vehicle is stopped as described below. For example, when the vehicle is stopped to wait for, for example, pedestrians to cross the road or for a traffic signal to change, the driver may gaze or look forward rather than rightward or leftward from the vehicle during the operation of the left direction indicator or the right direction indicator. Under such situations, the distracted driving determination apparatus disables the change of the determination criterion for the left or the right of the vehicle to correctly determine whether the driver is engaging in distracted driving.

A driving support system according to an eighth aspect of the disclosure includes the distracted driving determination apparatus according to any one of the first to seventh aspects further including an output unit that outputs an instruction signal for supporting the driver based on the determination result indicating that the driver is engaging in distracted driving, and a support apparatus that supports the driver in response to the instruction signal.

The driving support system according to the eighth aspect provides support including an alert for the driver who is engaging in detracted driving. This allows the driver to notice his or her distracted driving and refocus on driving.

A distracted driving determination method according to a ninth aspect of the disclosure includes obtaining first information indicating a gaze or a face orientation of a driver, obtaining second information indicating an operational state of a direction indicator, and comparing the gaze or the face orientation indicated by the first information with a predetermined criterion indicating a direction or a duration that varies depending on the operational state indicated by the second information to determine distracted driving.

The distracted driving determination method according to the ninth aspect can achieve the same advantageous effects as the distracted driving determination apparatus according to the first aspect.

A program for distracted driving determination according to a tenth aspect of the disclosure causes a computer to implement processes performed by the units included in the distracted driving determination apparatus according to any one of the first to seventh aspects.

The program for distracted driving determination according to the tenth aspect can achieve the same advantageous effects as the distracted driving determination apparatus according to the first aspect.

### Advantageous Effects

One or more aspects of the present invention provide a technique for improving the accuracy of distracted driving determination performed when the vehicle changes the traveling direction.

### BRIEF DESCRIPTION OF THE DRAWINGS

FIG. 1 is a schematic diagram describing an example use of a distracted driving determination apparatus according to an embodiment.

FIG. 2 is a schematic diagram of a vehicle including the distracted driving determination apparatus according to the present embodiment showing its overall structure.

FIG. 3 is a block diagram of the distracted driving determination apparatus according to the present embodiment showing its hardware configuration.

FIG. 4 is a schematic diagram describing a usual driving criterion.

FIG. 5 is a block diagram of the distracted driving determination apparatus according to the present embodiment showing its software configuration.

FIG. 6 is a schematic diagram describing a left criterion.

FIG. 7 is a schematic diagram describing a right criterion.

FIG. 8 is a flowchart showing distracted driving determination performed by the distracted driving determination apparatus according to the present embodiment.

FIG. 9 is a flowchart showing an example operation for changing a criterion performed by the distracted driving determination apparatus according to the present embodiment.

FIG. 10 is a flowchart showing another example operation for changing the criterion performed by the distracted driving determination apparatus according to the present embodiment.

### DETAILED DESCRIPTION

An embodiment of the present invention (hereafter, the present embodiment) will now be described with reference to the drawings. The present embodiment described below is a mere example in any aspect. The same or similar components as already described are given the same or similar reference numerals, and will not be described repeatedly. Although data used in the present embodiment is described in a natural language, such data may be specifically defined using a pseudo language, a command, a parameter, or a machine language.

### 1. EXAMPLE USE

A technique according to the present embodiment includes changing a criterion for detecting distracted driving while a right or left direction indicator is operating in response to a driver's operation. The criterion is either a direction or a duration. The direction is determined relative to the position of the driver. The duration is a time period for which the gaze or face orientation of the driver is allowed to reside within a predetermined range.

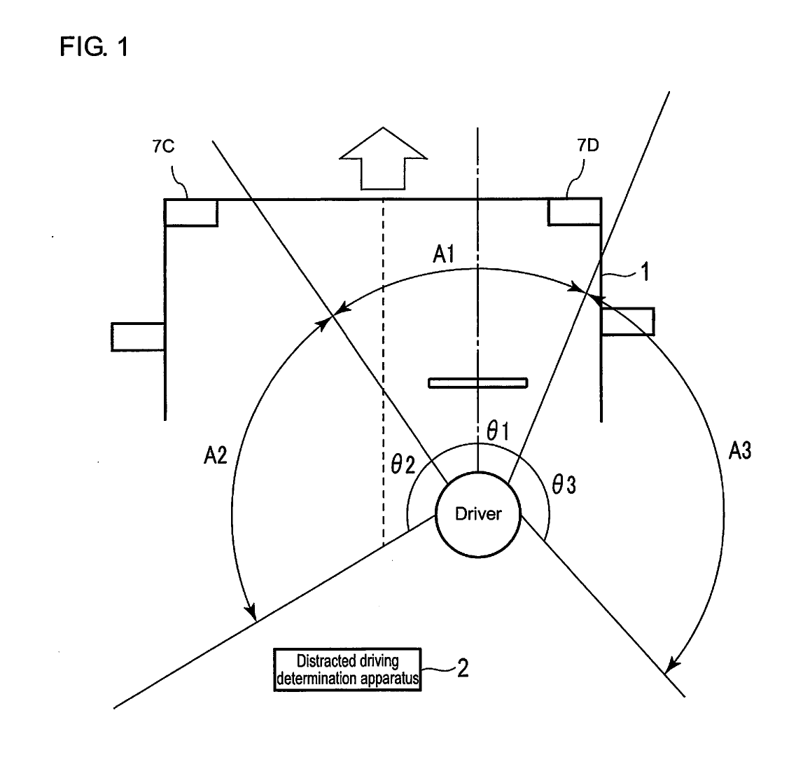

FIG. 1 is a schematic diagram describing an example use of a distracted driving determination apparatus 2, which is mounted on a vehicle 1. FIG. 1 shows the vehicle 1 with a right-hand steering wheel viewed from above. The radial solid lines indicate imaginary areas A1, A2, and A3. The broken line indicates the centerline in the width direction of the vehicle 1. The dot-and-dash line indicates the straight traveling direction of the vehicle 1.

The first area A1 is an imaginary area horizontally ranging from the driver toward the front of the vehicle 1 at a first angle θ1. The distracted driving determination apparatus 2 determines that the driver is not engaging in distracted driving when his or her gaze or face orientation is within the first area A1. The second area A2 is an imaginary area adjacent to the first area A1 and horizontally ranging from the driver toward the left of the vehicle 1 at a second angle θ2. The second area A2 is associated with a first duration for which the gaze or face orientation of the driver is allowed to reside within the area. The distracted driving determination apparatus 2 determines that the driver is engaging in distracted driving when his or her gaze or face orientation resides within the second area A2 for a duration longer than the first duration. The third area A3 is an imaginary area adjacent to the first area A1 and horizontally ranging from the driver toward the right of the vehicle 1 at a third angle N. The third area A3 is associated with a second duration for which the gaze or face orientation of the driver is allowed to reside within the area. The distracted driving determination apparatus 2 determines that the driver is engaging in distracted driving when his or her gaze or face orientation resides within the third area A3 for a duration longer than the second duration.

The distracted driving determination apparatus 2 determines distracted driving of the driver by comparing the gaze or face orientation of the driver with the criterion. As described below, the distracted driving determination apparatus 2 changes the criterion while a left direction indicator or a right direction indicator is operating.

The distracted driving determination apparatus 2 changes the criterion for the left of the vehicle 1 while the left direction indicator is operating. In response to an operation start of the left direction indicator, the distracted driving determination apparatus 2 shifts the boundary between the first and second areas A1 and A2 counterclockwise as viewed from the driver from the boundary position used when the left direction indicator and the right direction indicator are not operating. For example, the distracted driving determination apparatus 2 may increase the first angle θ1 of the first area A1 and decrease the second angle θ2 of the second area A2 without shifting the boundary between the first and third areas A1 and A3 and the end of the second area A2 opposite to the boundary between the first and second areas A1 and A2. This process equates to changing the direction included in the criterion relative to the position of the driver. This lowers the likelihood that distracted driving of the driver is detected for the left of the vehicle 1. In addition to or in place of this, the distracted driving determination apparatus 2 extends the first duration for the second area A2 in response to an operation start of the left direction indicator. This process equates to changing the allowable duration included in the criterion. This lowers the likelihood that distracted driving of the driver is detected for the left of the vehicle 1.

The distracted driving determination apparatus 2 changes the criterion for the right of the vehicle 1 while the right direction indicator is operating. In response to an operation start of the right direction indicator, the distracted driving determination apparatus 2 shifts the boundary between the first and third areas A1 and A3 clockwise as viewed from the driver from the boundary position used when the left direction indicator and the right direction indicator are not operating. For example, the distracted driving determination apparatus 2 increases the first angle θ1 of the first area A1 and decreases the third angle θ3 of the third area A3 without shifting the boundary between the first and second areas A1 and A2 and the end of the third area A3 opposite to the boundary between the first and third areas A1 and A3. This process equates to changing the direction included in the criterion relative to the position of the driver. This lowers the likelihood that distracted driving of the driver is detected for the right of the vehicle 1. In addition to or in place of this, the distracted driving determination apparatus 2 extends the second duration for the third area A3 in response to an operation start of the right direction indicator. This process equates to changing the allowable duration included in the criterion. This lowers the likelihood that distracted driving of the driver is detected for the right of the vehicle 1.

As described above, the distracted driving determination apparatus 2 can improve the accuracy of distracted driving determination performed when the vehicle 1 changes the traveling direction.

### 2. EXAMPLE CONFIGURATION

### Vehicle

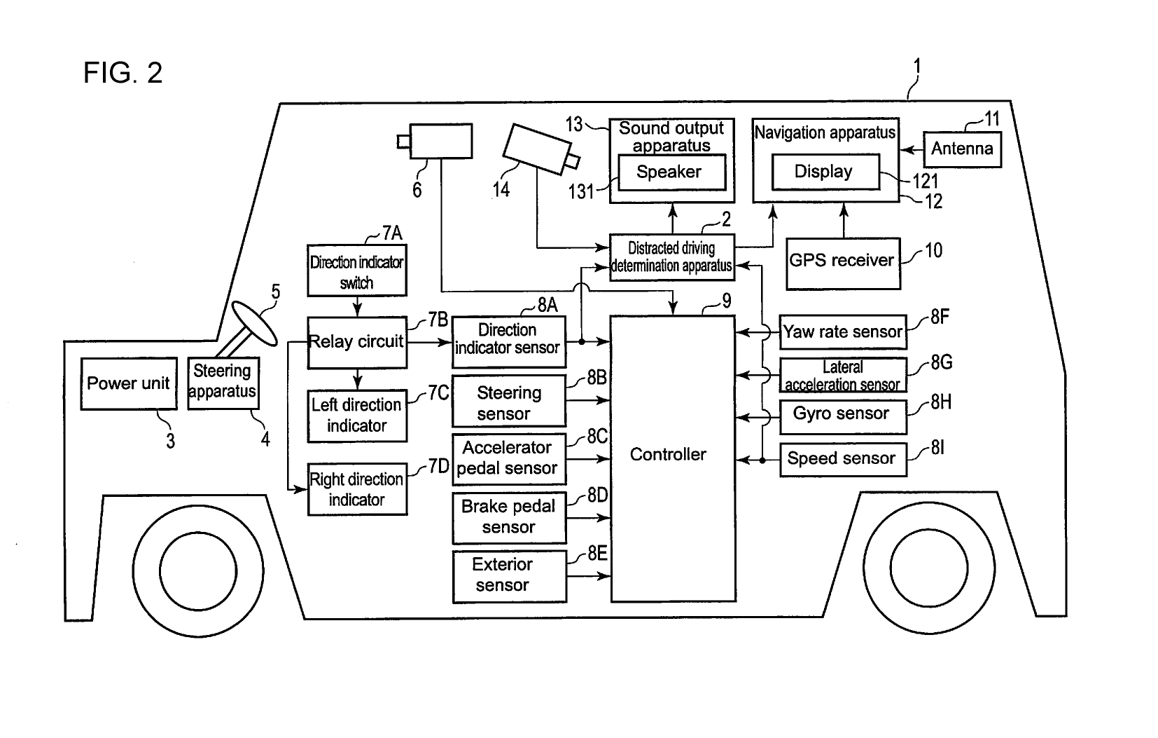

FIG. 2 is a schematic diagram of the vehicle 1 including the distracted driving determination apparatus 2. The vehicle 1 may be any of, for example, an automobile, a bus, a truck, and a train or may be any other vehicle drivable by a driver.

The vehicle 1 includes the distracted driving determination apparatus 2, a power unit 3, a steering apparatus 4, a steering wheel 5, an exterior view camera 6, a direction indicator switch 7A, a relay circuit 7B, a left direction indicator 7C, a right direction indicator 7D, a direction indicator sensor 8A, a steering sensor 8B, an accelerator pedal sensor 8C, a brake pedal sensor 8D, an exterior sensor 8E, a yaw rate sensor 8F, a lateral acceleration sensor 8G, a gyro sensor 8H, a speed sensor 8I, a controller 9, a global positioning system (GPS) receiver 10, an antenna apparatus 11, a navigation apparatus 12, a sound output apparatus 13, and a driver camera 14.

The distracted driving determination apparatus 2 determines whether the driver is engaging in distracted driving based on the gaze or face orientation of the driver and the distracted driving determination criterion. The criterion is either a direction or a duration. The direction is determined relative to the position of the driver. The duration is a time period for which the gaze or face orientation of the driver is allowed to reside within a predetermined range (hereafter, an allowable duration). Examples of the criteria will be described later. Distracted driving may also be referred to as inattentive driving.

The components of the distracted driving determination apparatus 2 will be described later.

The power unit 3 includes a power source and a transmission. The power source includes an engine or a motor or both.

The steering apparatus 4 changes the traveling direction of the vehicle 1.

The steering wheel 5 is connected to the steering apparatus 4. The steering wheel 5 is operated by the driver to change the traveling direction of the vehicle 1.

The exterior view camera 6 captures an image of the exterior of the vehicle 1. For example, the exterior view camera 6 constantly captures images in front of the vehicle 1. The exterior view camera 6 outputs the captured images (hereafter, exterior image data) to the controller 9. The exterior view camera 6 is installed at a given position of the vehicle 1. Although FIG. 1 shows the single exterior view camera 6, the vehicle 1 may include multiple exterior view cameras 6 for capturing images in different directions.

The direction indicator switch 7A is operated by the driver to activate the left direction indicator 7C or the right direction indicator 7D when changing the traveling direction of the vehicle 1. When changing the traveling direction of the vehicle 1 leftward, the driver manually switches the direction indicator switch 7A from its initial position to a first position. When changing the traveling direction of the vehicle 1 rightward, the driver manually switches the direction indicator switch 7A from its initial position to a second position. The direction indicator switch 7A is manually switched by the driver from the first position or the second position back to the initial position. The direction indicator switch 7A may switch from the first position back to the initial position in cooperation with when the driver operating the steering wheel 5 counterclockwise operates the steering wheel 5 back to its initial position. Similarly, the direction indicator switch 7A may switch from the second position back to the initial position in cooperation with when the driver operating the steering wheel clockwise operates the steering wheel back to the initial position.

The relay circuit 7B supplies power to the left direction indicator 7C or the right direction indicator 7D in accordance with the position of the direction indicator switch 7A. The relay circuit 7B starts supplying power to the left direction indicator 7C in response to switching of the direction indicator switch 7A from the initial position to the first position. The relay circuit 7B continuously supplies power to the left direction indicator 7C while the direction indicator switch 7A is at the first position. The relay circuit 7B stops supplying power to the left direction indicator 7C in response to switching of the direction indicator switch 7A from the first position to the initial position. Similarly, the relay circuit 7B starts supplying power to the right direction indicator 7D in response to switching of the direction indicator switch 7A from the initial position to the second position. The relay circuit 7B continuously supplies power to the right direction indicator 7D while the direction indicator switch 7A is at the second position. The relay circuit 7B stops supplying power to the right direction indicator 7D in response to switching of the direction indicator switch 7A from the second position to the initial position.

The left direction indicator 7C is connected to the relay circuit 7B. The left direction indicator 7C includes, for example, a lightbulb or a light-emitting diode (LED). The left direction indicator 7C may be mounted on a left part of the vehicle 1. Although FIG. 1 shows the single left direction indicator 7C, the vehicle 1 includes multiple left direction indicators 7C at positions including a left front end and a left rear end of the vehicle 1. The left direction indicator 7C blinks when powered through the relay circuit 7B.

The right direction indicator 7D is connected to the relay circuit 7B. The right direction indicator 7D includes, for example, a lightbulb or an LED. The right direction indicator 7D may be mounted on a right part of the vehicle 1. Although FIG. 1 shows the single right direction indicator 7D, the vehicle 1 includes multiple right direction indicators 7D at multiple positions including a right front end and a right rear end of the vehicle 1. The right direction indicator 7D blinks when powered through the relay circuit 7B.

The direction indicator sensor 8A is included in the relay circuit 7B. The direction indicator sensor 8A detects an operation start and an operation end of the left direction indicator 7C based on the state of power supply to the left direction indicator 7C through the relay circuit 7B. The direction indicator sensor 8A detects an operation start and an operation end of the right direction indicator 7D based on the state of power supply to the right direction indicator 7D through the relay circuit 7B. The direction indicator sensor 8A outputs detection information indicating the operational state of each direction indicator to the distracted driving determination apparatus 2 and the controller 9. The direction indicator includes the left direction indicator 7C and the right direction indicator 7D. The detection information indicating the operational state of each direction indicator indicates an operational state selected from an operation start of the left direction indicator 7C, an operation end of the left direction indicator 7C, an operation start of the right direction indicator 7D, and an operation end of the right direction indicator 7D.

The steering sensor 8B detects a steering angle. The steering sensor 8B outputs detection information indicating the steering angle to the controller 9.

The accelerator pedal sensor 8C detects an operational quantity of an accelerator pedal. The accelerator pedal sensor 8C outputs detection information indicating the operational quantity of the accelerator pedal to the controller 9.

The brake pedal sensor 8D detects an operational quantity of a brake pedal. The brake pedal sensor 8D outputs detection information indicating the operational quantity of the brake pedal to the controller 9.

The exterior sensor 8E may be, for example, a millimeter wave sensor.

The exterior sensor 8E detects the position of an object external to the vehicle 1. The exterior sensor 8E outputs detection information indicating the position of the object to the controller 9.

The yaw rate sensor 8F detects a rotational angle velocity about the vertical axis of the vehicle 1. The yaw rate sensor 8F outputs detection information indicating the rotational angle velocity to the controller 9.

The lateral acceleration sensor 8G detects an acceleration in a lateral direction (width direction) of the vehicle 1 (hereafter, lateral acceleration). The lateral acceleration sensor 8G outputs detection information indicating the lateral acceleration to the controller 9.

The gyro sensor 8H detects the behavior of the vehicle 1. The gyro sensor 8H outputs detection information indicating a quantity associated with the behavior of the vehicle 1 to the controller 9.

The speed sensor 8I detects the speed of the vehicle 1. The speed sensor 8I outputs detection information indicating the speed to the distracted driving determination apparatus 2 and the controller 9.

The controller 9 receives exterior image data from the exterior view camera 6 and detection information from the direction indicator sensor 8A, the steering sensor 8B, the accelerator pedal sensor 8C, the brake pedal sensor 8D, the exterior sensor 8E, the yaw rate sensor 8F, the lateral acceleration sensor 8G, the gyro sensor 8H, and the speed sensor 8I. The controller 9 uses detection information from at least one of these sensors to support driving of the vehicle 1.

The GPS receiver 10 receives GPS signals transmitted from multiple GPS satellites, and calculates the current location of the vehicle 1 based on the GPS signals. The GPS receiver 10 outputs information indicating the current location (hereafter, current location information) to the navigation apparatus 12.

The antenna apparatus 11 receives road traffic information, or specifically information from the Vehicle Information and Communication System (VICS, registered trademark), with at least one of frequency modulation (FM) multiplex broadcasting, a radio wave beacon, and a light beacon. The road traffic information includes, for example, traffic jam information and traffic control information. The antenna apparatus 11 transmits the road traffic information to the navigation apparatus 12.

The navigation apparatus 12 is an example of an image display device including a display 121 for displaying an image. The navigation apparatus 12 stores map data. The map data includes information about the features of roads.

The navigation apparatus 12 uses information about a destination input by, for example, the driver, map data, and current location information from the GPS receiver 10 to extract information about routes from the current location to the destination. The navigation apparatus 12 displays the route information on the display 121. The navigation apparatus 12 displays road traffic information from the antenna apparatus 11 on the display 121. The navigation apparatus 12 may display information other than the route information and the road traffic information on the display 121.

The sound output apparatus 13 includes a speaker 131. The sound output apparatus 13 outputs various items of information using sounds.

The driver camera 14 constantly captures images of a predefined range including the face of the driver. The driver camera 14 is installed in front of the driver, for example, on a dashboard. The driver camera 14 is an example of a sensor for monitoring the driver. The driver camera 14 captures images (hereafter, driver image data) and outputs the data to the distracted driving determination apparatus 2. The driver image data is an example of monitoring data used for detecting distracted driving of the driver.

### Distracted Driving Determination Apparatus

### Hardware Configuration

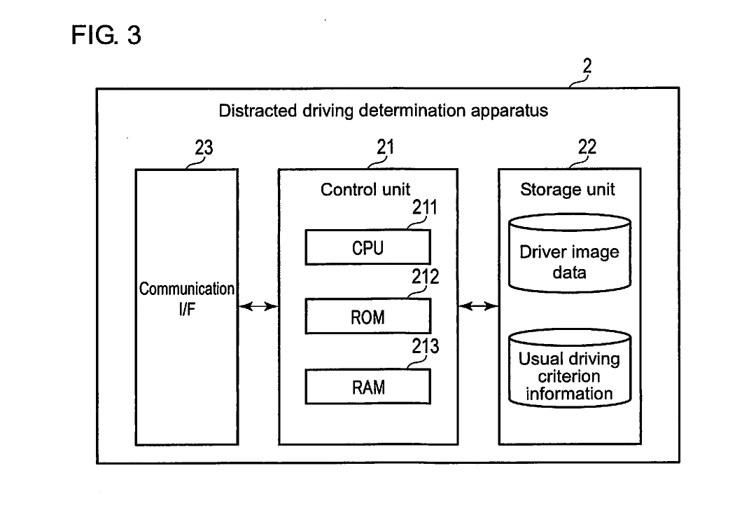

FIG. 3 is a block diagram of the distracted driving determination apparatus 2 showing its hardware configuration.

The distracted driving determination apparatus 2 includes a control unit 21, a storage unit 22, and a communication interface 23, which are electrically connected to one another. In FIG. 3, the communication interface is abbreviated as the communication I/F.

The control unit 21 will now be described.

The control unit 21 controls the operation of each unit in the distracted driving determination apparatus 2. The control unit 21 includes a central processing unit (CPU) 211, a read only memory (ROM) 212, and a random access memory (RAM) 213.

The CPU 211 is an example of a processor. The CPU 211 expands, in the RAM 213, programs stored in the storage unit 22 for implementing the distracted driving determination apparatus 2. The CPU 211 then interprets and executes the programs expanded in the RAM 213. This allows the control unit 21 to implement the function of each unit in the software configuration described later.

The storage unit 22 will now be described.

The storage unit 22 is an auxiliary storage device. The storage unit 22 may be, but not limited to, a hard disk drive (HDD). The storage unit 22 stores programs executable by the control unit 21. The programs enable the distracted driving determination apparatus 2 to function as each unit in the software configuration described later. The programs may be stored in the storage unit 22, or may be downloaded to the distracted driving determination apparatus 2 through a network. The programs may be stored in a non-transitory computer-readable medium, such as a compact disc read-only memory (CD-ROM) and distributed.

The storage unit 22 stores data used by the control unit 21 as described below.

The storage unit 22 stores driver image data received from the driver camera 14 to the control unit 21. For example, the control unit 21 receives the driver image data from the driver camera 14 at predetermined intervals and stores the data into the storage unit 22.

The storage unit 22 stores information (usual driving criterion information) indicating a criterion for usual driving (usual driving criterion), which is one criterion for detecting distracted driving.

Usual driving herein refers to driving when the left direction indicator 7C and the right direction indicator 7D are not operating. In addition to driving when the left direction indicator 7C and the right direction indicator 7D are not operating, usual driving may include driving of the vehicle 1 at a predetermined speed and faster or driving in the traveling direction deviating from the straight traveling direction within a predetermined range.

Examples of the usual driving criterion will be described later.

The communication interface 23 will now be described.

The communication interface 23 connects the direction indicator sensor 8A, the speed sensor 8I, the navigation apparatus 12, the sound output apparatus 13, and the driver camera 14 to the control unit 21. The communication interface 23 may include an interface for cable communication or an interface for wireless communication.

For the specific hardware configuration of the distracted driving determination apparatus 2, components may be eliminated, substituted, or added as appropriate. For example, the control unit 21 may include multiple processors.

### Usual Driving Criterion

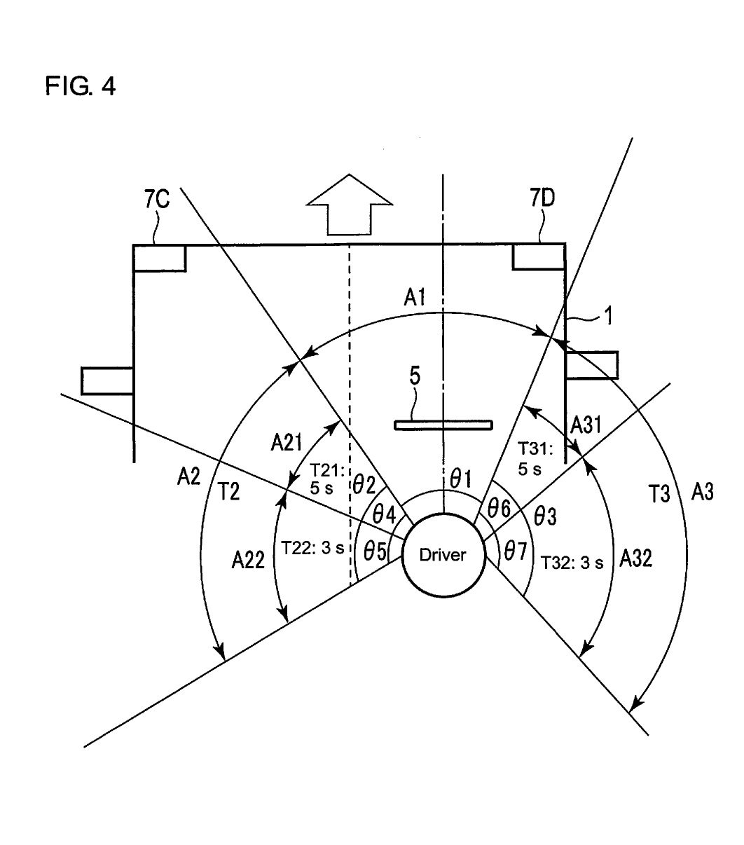

FIG. 4 is a schematic diagram describing a usual driving criterion used for the right-hand steering wheel. FIG. 4 is a plan view of the vehicle 1 with the right-hand steering wheel as viewed from above. The radial solid lines indicate the imaginary areas A1, A2, and A3. The broken line indicates the centerline in the width direction of the vehicle 1. The dot-and-dash line indicates the straight traveling direction of the vehicle 1.

The usual driving criterion includes a criterion during usual driving for the imaginary first area A1, the imaginary second area A2, and the imaginary third area A3, which are defined around the driver.

The first area A1 will now be described.

The first area A1 is an imaginary area ranging from the driver toward the front of the vehicle 1. For example, the first area A1 horizontally ranges from the driver toward the front of the vehicle 1 at the first angle θ1. As described later, the distracted driving determination apparatus 2 determines that the driver is not engaging in distracted driving when his or her gaze or face orientation is within the first area A1.

The usual driving criterion defines, for example, the first area A1 including the straight traveling direction of the vehicle 1. The usual driving criterion defines the first angle θ1 as a predetermined angle. The predetermined angle may be set to any angle.

The second area A2 will now be described.

The second area A2 is an imaginary area adjacent to the first area A1 and ranging from the driver toward the left of the vehicle 1. For example, the second area A2 horizontally ranges from the driver toward the left of the vehicle 1 at the second angle θ2. The second area A2 is associated with an allowable duration T2. The allowable duration T2 is an example of the first duration for which the gaze or face orientation of the driver is allowed to reside within a predetermined range inside at least a part of the second area. As described later, the distracted driving determination apparatus 2 thus determines that the driver is engaging in distracted driving when his or her gaze or face orientation resides within the second area A2 for a duration longer than the first duration.

The usual driving criterion defines the position of the second area A2 using the boundary position between the first and second areas A1 and A2 and the second angle θ2. The usual driving criterion defines the boundary position between the first and second areas A1 and A2 as a predetermined position. The predetermined position may be set to any position. The usual driving criterion defines the second angle θ2 as a predetermined angle. The predetermined angle may be set to any angle.

The usual driving criterion defines the second area A2 including a sub-area A21 and a sub-area A22, which are associated with the allowable durations having different lengths.

The sub-area A21 is an imaginary area adjacent to the first area A1 and ranging from the driver toward the left of the vehicle 1. For example, the sub-area A21 horizontally ranges from the driver toward the left of the vehicle 1 at a fourth angle θ4.

The usual driving criterion defines the position of the sub-area A21 using the boundary position between the first and second areas A1 and A2 and the fourth angle θ4. The usual driving criterion defines the fourth angle θ4 as a predetermined angle. The predetermined angle may be set to any angle.

The length of an allowable duration T21, which is associated with the sub-area A21, may be, but not limited to, five seconds. The allowable duration T21 is an example of the first duration.

The sub-area A22 is an imaginary area adjacent to the sub-area A21 and ranging from the driver toward the left of the vehicle 1. For example, the sub-area A22 horizontally ranges from the driver toward the left of the vehicle 1 at a fifth angle θ5.

The usual driving criterion defines the position of the sub-area A22 using the position of the sub-area A21 and the fifth angle θ5. The usual driving criterion defines the fifth angle θ5 as a predetermined angle. The predetermined angle may be set to any angle.

The length of an allowable duration T22, which is associated with the sub-area A22, may be, but not limited to, three seconds. The allowable duration T22 is an example of the first duration. The allowable duration T22 associated with the sub-area A22 is shorter than the allowable duration T21 associated with the sub-area A21. This is because the sub-area A22 is located rearward from the sub-area A21 in the vehicle 1 and thus is likely to affect the safety of driving when the gaze or face orientation of the driver resides within the sub-area A22 for a long time whether or not for distracted driving or for checking for any obstacle before turning.

Although the second area A2 includes two sub-areas, the second area A2 may include no sub-area. In some embodiments, the second area A2 may include three or more sub-areas. In this case, the allowable duration associated with each sub-area is shorter as the sub-area is farther from the boundary between the first and second areas A1 and A2 counterclockwise as viewed from the driver.

The third area A3 will now be described.

The third area A3 is an imaginary area adjacent to the first area A1 and ranging from the driver toward the right of the vehicle 1. For example, the third area A3 horizontally ranges from the driver toward the right of the vehicle 1 at the third angle θ3. The third area A3 is associated with an allowable duration T3. The allowable duration T3 is an example of the second duration for which the gaze or face orientation of the driver is allowed to reside within a predetermined range inside at least a part of the third area. As described later, the distracted driving determination apparatus 2 thus determines that the driver is engaging in distracted driving when his or her gaze or face orientation resides within the third area A3 for a duration longer than the second duration.

The usual driving criterion defines the position of the third area A3 using the boundary position between the first and third areas A1 and A3 and the third angle θ3. The usual driving criterion defines the boundary position between the first and third areas A1 and A3 as a predetermined position. The predetermined position may be set to any position. The usual driving criterion defines the third angle 63 as a predetermined angle. The predetermined angle may be set to any angle.

The usual driving criterion defines the third area A3 including a sub-area A31 and a sub-area A32, which are associated with allowable durations having different lengths.

The sub-area A31 is an imaginary area adjacent to the first area A1 and ranging from the driver toward the right of the vehicle 1. For example, the sub-area A31 horizontally ranges from the driver toward the right of the vehicle 1 at a sixth angle θ6.

The usual driving criterion defines the position of the sub-area A31 using the boundary position between the first and third areas A1 and A3 and the sixth angle θ6. The usual driving criterion defines the sixth angle θ6 as a predetermined angle. The predetermined angle may be set to any angle.

The length of an allowable duration T31, which is associated with the sub-area A31, may be, but not limited to, five seconds. The allowable duration T31 is an example of the second duration.

The sub-area A32 is an imaginary area adjacent to the sub-area A31 and ranging from the driver toward the right of the vehicle 1. For example, the sub-area A32 horizontally ranges from the driver toward the right of the vehicle 1 at a seventh angle 97.

The usual driving criterion defines the position of the sub-area A32 using the position of the sub-area A31 and the seventh angle 97. The usual driving criterion defines the seventh angle θ7 as a predetermined angle. The predetermined angle may be set to any angle.

The length of an allowable duration T32, which is associated with the sub-area A32, may be, but not limited to, three seconds. The allowable duration T32 is an example of the second duration. The allowable duration T32 associated with the sub-area A32 is shorter than the allowable duration T31 associated with the sub-area A31. This is because the sub-area A32 is located rearward from the sub-area A31 in the vehicle 1 and thus is likely to affect the safety of driving when the gaze or face orientation of the driver resides within the sub-area A32 for a long time whether or not for distracted driving or for checking for any obstacle before turning.

Although the third area A3 includes two sub-areas, the third area A3 may include no sub-area. In some embodiments, the third area A3 may include three or more sub-areas. In this case, the allowable duration associated with each sub-area is shorter as the sub-area is farther from the boundary between the first and third areas A1 and A3 clockwise as viewed from the driver.

The deviation (angle) of the boundary between the first and second areas A1 and A2 from the straight traveling direction of the vehicle 1 may or may not have the same absolute value as the deviation (angle) of the boundary between the first and third areas A1 and A3 from the straight traveling direction of the vehicle 1. The deviation (angle) of the boundary between the sub-areas A21 and A22 from the straight traveling direction of the vehicle 1 may or may not have the same absolute value as the deviation (angle) of the boundary between the sub-areas A31 and A32 from the straight traveling direction of the vehicle 1.

The usual driving criterion described above, which is used for the right-hand steering wheel, may also be used for a left-hand steering wheel. The multiple areas defined around the driver under the usual driving criterion for the left-hand steering wheel may or may not be the same as the multiple areas defined around the driver under the usual driving criterion for the right-hand steering wheel. As described below, the multiple areas defined around the driver under the usual driving criterion for the left-hand steering wheel may be the reverse about an axis in the straight traveling direction of the vehicle 1 from the multiple areas defined around the driver under the usual driving criterion for the right-hand steering wheel.

The first angle θ1 of the first area A1 under the usual driving criterion for the left-hand steering wheel is the same as the first angle θ1 under the usual driving criterion for the right-hand steering wheel. The deviation (angle) of the boundary between the first and second areas A1 and A2 from the straight traveling direction of the vehicle 1 under the usual driving criterion for the left-hand steering wheel has the same absolute value as the deviation (angle) of the boundary between the first and third areas A1 and A3 from the straight traveling direction of the vehicle 1 under the usual driving criterion for the right-hand steering wheel. The deviation (angle) of the boundary between the first and third areas A1 and A3 from the straight traveling direction of the vehicle 1 under the usual driving criterion for the left-hand steering wheel has the same absolute value as the deviation (angle) of the boundary between the first and second areas A1 and A2 from the straight traveling direction of the vehicle 1 under the usual driving criterion for the right-hand steering wheel.

The second angle θ2 of the second area A2 under the usual driving criterion for the left-hand steering wheel is the same as the third angle θ3 under the usual driving criterion for the right-hand steering wheel. The fourth angle θ4 of the sub-area A21 under the usual driving criterion for the left-hand steering wheel is the same as the sixth angle θ6 of the sub-area A31 under the usual driving criterion for the right-hand steering wheel. The allowable duration T21 associated with the sub-area A21 under the usual driving criterion for the left-hand steering wheel has the same length as the allowable duration T31 associated with the sub-area A31 under the usual driving criterion for the right-hand steering wheel. The fifth angle θ5 of the sub-area A22 under the usual driving criterion for the left-hand steering wheel is the same as the seventh angle θ7 of the sub-area A32 under the usual driving criterion for the right-hand steering wheel. The allowable duration T22 associated with the sub-area A22 under the usual driving criterion for the left-hand steering wheel has the same length as the allowable duration T32 associated with the sub-area A32 under the usual driving criterion for the right-hand steering wheel.

The third angle θ3 of the third area A3 under the usual driving criterion for the left-hand steering wheel is the same as the second angle θ2 under the usual driving criterion for the right-hand steering wheel. The sixth angle θ6 of the sub-area A31 under the usual driving criterion for the left-hand steering wheel is the same as the fourth angle θ4 of the sub-area A21 under the usual driving criterion for the right-hand steering wheel. The allowable duration T31 associated with the sub-area A31 under the usual driving criterion for the left-hand steering wheel has the same length as the allowable duration T21 associated with the sub-area A21 under the usual driving criterion for the right-hand steering wheel. The seventh angle θ7 of the sub-area A32 under the usual driving criterion for the left-hand steering wheel is the same as the fifth angle θ5 of the sub-area A22 under the usual driving criterion for the right-hand steering wheel. The allowable duration T32 associated with the sub-area A32 under the usual driving criterion for the left-hand steering wheel has the same length as the allowable duration T22 associated with the sub-area A22 under the usual driving criterion for the right-hand steering wheel.

### Software Configuration

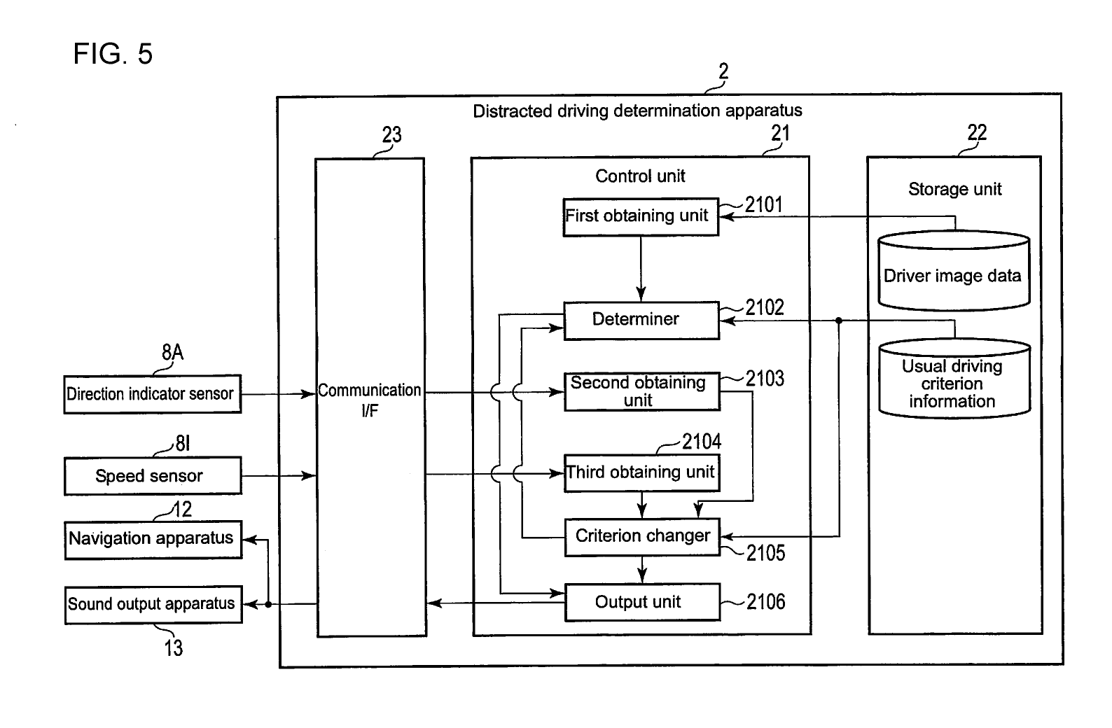

FIG. 5 is a block diagram of the distracted driving determination apparatus 2 showing its software configuration.

The control unit 21 includes a first obtaining unit 2101, a determiner 2102, a second obtaining unit 2103, a third obtaining unit 2104, a criterion changer 2105, and an output unit 2106.

The first obtaining unit 2101 will now be described.

The first obtaining unit 2101 obtains first information indicating the gaze or face orientation of the driver as described below.

The first obtaining unit 2101 first obtains the driver image data for the driver of the vehicle 1. The first obtaining unit 2101 may constantly obtain the driver image data from the storage unit 22. In some embodiments, the first obtaining unit 2101 may constantly obtain the driver image data from the driver camera 14. The first obtaining unit 2101 then determines, for example, the state of the eyes of the driver captured in the driver image data to detect the gaze or face orientation of the driver. Thus, the first obtaining unit 2101 obtains the first information indicating the gaze or face orientation of the driver.

The first obtaining unit 2101 outputs the first information to the determiner 2102.

The determiner 2102 will now be described.

As described below, the determiner 2102 determines distracted driving of the driver by comparing the gaze or face orientation of the driver indicated by the first information with the criterion. The criterion may vary depending on the operational state of each direction indicator indicated by second information obtained by the second obtaining unit 2103, which will be described later. The second information indicates the operational state of each direction indicator. The operational state of each direction indicator indicated by the second information during a period from an operation end to an operation start of the left direction indicator 7C or the right direction indicator 7D is associated with the vehicle 1 traveling straight. The operational state of the direction indicator indicated by the second information during a period from an operation start to an operation end of the left direction indicator 7C is associated with the vehicle 1 turning left. The operational state of the direction indicator indicated by the second information during a period from an operation start to an operation end of the right direction indicator 7D is associated with the vehicle 1 turning right. The criterion defining the directional range around the driver or the length of the allowable duration differs among different states of driving, or driving straight, turning left, and turning right. In the example described below, the criterion differs among the usual driving criterion associated with the straight traveling direction, a left criterion associated with the left turn direction (described later), and a right criterion associated with the right turn direction (described later).

The determiner 2102 first receives the first information from the first obtaining unit 2101. The determiner 2102 then obtains the criterion. When the distracted driving determination apparatus 2 is activated, the determiner 2102 obtains the usual driving criterion information from the storage unit 22 and uses the usual driving criterion. When the criterion is changed by the criterion changer 2105 (described later), the determiner 2102 receives information specifying the changed criterion from the criterion changer 2105. The determiner 2102 may use the resultant criterion.

The determiner 2102 determines that the driver is not engaging in distracted driving when his or her gaze or face orientation is within the first area A1. The determiner 2102 determines that the driver is engaging in distracted driving when his or her gaze or face orientation resides within the second area A2 for a duration longer than the first duration. In other words, the determiner 2102 determines that the driver is not engaging in distracted driving when his or her gaze or face orientation resides continuously within the second area A2 for a duration equal to or shorter than the first duration. The determiner 2102 determines that the driver is engaging in distracted driving when his or her gaze or face orientation resides continuously within the third area A3 for a duration longer than the second duration. In other words, the determiner 2102 determines that the driver is not engaging in distracted driving when his or her gaze or face orientation resides continuously within the third area A3 for a duration equal to or shorter than the second duration.

When determining that the driver is engaging in distracted driving, the determiner 2102 outputs a determination result indicating that the driver is engaging in distracted driving to the output unit 2106.

The second obtaining unit 2103 will now be described.

The second obtaining unit 2103 obtains the second information indicating the operational state of each direction indicator as described below.

The second obtaining unit 2103 obtains the second information indicating the operational state of each direction indicator from the direction indicator sensor 8A. The second obtaining unit 2103 outputs the second information to the criterion changer 2105.

The third obtaining unit 2104 will now be described.

The third obtaining unit 2104 obtains third information indicating the traveling state of the vehicle 1 as described below.

The third obtaining unit 2104 first obtains detection information indicating a speed obtained from the speed sensor 8I. The third obtaining unit 2104 then determines whether the vehicle 1 is traveling or stopped based on the detection information indicating the speed, and thus obtains third information. The third obtaining unit 2104 may determine that the vehicle 1 is stopped when the speed is not zero but is less than or equal to a predetermined threshold. More specifically, the vehicle 1 being stopped may include the vehicle being substantially stopped at the speed less than or equal to a threshold, in addition to the vehicle at the speed of zero. The third information indicates whether the vehicle 1 is traveling or stopped.

The third obtaining unit 2104 outputs the third information to the criterion changer 2105.

The criterion changer 2105 will now be described.

As described below, the criterion changer 2105 changes the criterion. In the example described below, the criterion changer 2105 changes the criterion for directions in which the direction indicators operate.

The criterion changer 2105 first receives the usual driving criterion from the storage unit 22. The criterion changer 2105 then receives the second information from the second obtaining unit 2103. The criterion changer 2105 detects an operation start or an operation end of the left direction indicator 7C or the right direction indicator 7D based on the second information.

The criterion changer 2105 then changes the criterion based on the second information while the direction indicators are operating.

As described below, the criterion changer 2105 changes the criterion for the left of the vehicle 1 during the operation of the left direction indicator 7C based on the second information.

In response to an operation start of the left direction indicator 7C, the criterion changer 2105 determines that the operational state of the direction indicator indicated by the second information is associated with the vehicle 1 turning left, and thus performs a first change process. In response to an operation start of the left direction indicator 7C, the criterion changer 2105 performs the first change process, or shifts the boundary between the first and second areas A1 and A2 counterclockwise as viewed from the driver from the boundary position used when the left direction indicator 7C and the right direction indicator 7D are not operating. This process equates to changing the direction included in the criterion relative to the position of the driver. This lowers the likelihood that distracted driving of the driver is detected for the left of the vehicle 1. In addition to or in place of this, the criterion changer 2105 extends the first duration for the second area A2 in the first change process in response to an operation start of the left direction indicator 7C. This process equates to changing the allowable duration included in the criterion. This lowers the likelihood that distracted driving of the driver is detected for the left of the vehicle 1. The criterion resulting from the first change process for the usual driving criterion is referred to as the left criterion. The criterion changer 2105 determines to use the left criterion. In response to an operation end of the left direction indicator 7C, the criterion changer 2105 determines that the operational state of each direction indicator indicated by the second information is associated with the vehicle 1 traveling straight, and then changes the criterion from the left criterion back to the usual driving criterion. The criterion changer 2105 determines to use the usual driving criterion.

As described below, the criterion changer 2105 changes the criterion for the right of the vehicle 1 during the operation of the right direction indicator 7D based on the second information.

In response to an operation start of the right direction indicator 7D, the criterion changer 2105 determines that the operational state of the direction indicator indicated by the second information is associated with the vehicle 1 turning right, and thus performs a second change process. In response to an operation start of the right direction indicator 7D, the criterion changer 2105 performs the second change process, or shifts the boundary between the first and third areas A1 and A3 to a position rotated clockwise as viewed from the driver from the boundary position used when the left direction indicator 7C and the right direction indicator 7D are not operating. This process equates to changing the direction included in the criterion relative to the position of the driver. This lowers the likelihood that distracted driving of the driver is detected for the right of the vehicle 1. In addition to or in place of this, the criterion changer 2105 extends the second duration for the third area A3 in the second change process in response to an operation start of the right direction indicator 7D. This process equates to changing the allowable duration included in the criterion. This lowers the likelihood that distracted driving of the driver is detected for the right of the vehicle 1. The criterion resulting from the second change process for the usual driving criterion is referred to as the right criterion. The criterion changer 2105 determines to use the right criterion. In response to an operation end of the right direction indicator 7D, the criterion changer 2105 determines that the operational state of each direction indicator indicated by the second information is associated with the vehicle 1 traveling straight, and changes the criterion from the right criterion back to the usual driving criterion. The criterion changer 2105 determines to use the usual driving criterion.

The criterion changer 2105 outputs information specifying the criterion to the determiner 2102 upon every change of the criterion. The information specifying the criterion may be information indicating the usual driving criterion, the left criterion, or the right criterion.

The first change process may or may not be the same as the second change process. In one example, when the first change process shifts the boundary between the first and second areas A1 and A2, the second change process may shift the boundary between the first and third areas A1 and A3 or extend the second duration for the third area A3 or may include both the processes. In another example, when the first change process extends the first duration for the second area A2, the second change process may shift the boundary between the first and third areas A1 and A3 or extend the second duration for the third area A3 or may include both the processes. In still another example, when the first change process shifts the boundary between the first and second areas A1 and A2 and extends the first duration for the second area A2, the second change process may shift the boundary between the first and third areas A1 and A3 or extend the second duration for the third area A3 or may include both the processes.

The criterion changer 2105 may determine whether to perform the first change process and the second change process as described below based on the third information received from the third obtaining unit 2104.

The criterion changer 2105 first obtains the third information indicating whether the vehicle 1 is traveling or stopped from the third obtaining unit 2104. The criterion changer 2105 then determines whether the vehicle 1 is traveling based on the third information.

The criterion changer 2105 then performs the first change process in response to an operation start of the left direction indicator 7C during traveling of the vehicle 1. Similarly, the criterion changer 2105 performs the second change process in response to an operation start of the right direction indicator 7D during traveling of the vehicle 1. When determining that the vehicle 1 is stopped, the criterion changer 2105 disables the change of the criterion. In other words, the criterion changer 2105 that has detected an operation start of the left direction indicator 7C does not perform the first change process while the vehicle 1 is stopped. Similarly, the criterion changer 2105 that has detected an operation start of the right direction indicator 7D does not perform the second change process while the vehicle 1 is stopped.

The output unit 2106 will now be described.

As described below, the output unit 2106 outputs an instruction signal to support the driver based on the determination result indicating that the driver is engaging in distracted driving.

The output unit 2106 first obtains the determination result indicating that the driver is engaging in distracted driving from the determiner 2102. The output unit 2106 then outputs an instruction signal to a support apparatus based on the determination result indicating that the driver is engaging in distracted driving.

The support apparatus may include the navigation apparatus 12 and the sound output apparatus 13. The support apparatus may include, for example, an apparatus that externally stimulates the driver by providing vibrations for example, in addition to the navigation apparatus 12 and the sound output apparatus 13. The support apparatus that has received the instruction signal from the output unit 2106 starts supporting the driver. Supporting the driver includes providing an output that acts on the driver, including an alert, a caution, and notification, and various other forms of support to improve the driver's focus on driving.

A system including the distracted driving determination apparatus 2 and the support apparatus may be referred to as a driving support system.

### Left Criterion

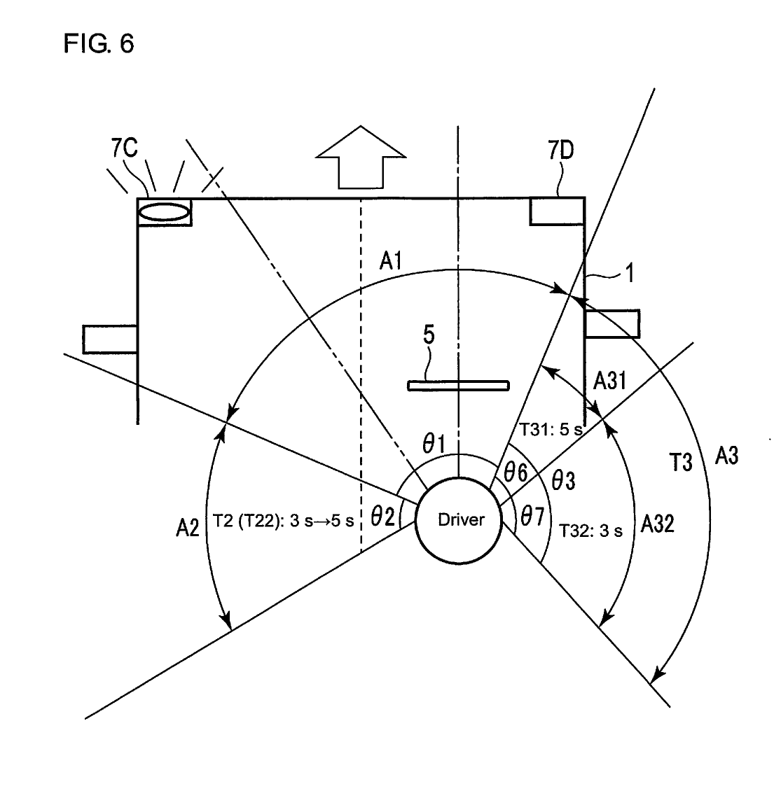

FIG. 6 is a schematic diagram describing the left criterion resulting from the first change process for the usual driving criterion. In the example shown in FIG. 6, the boundary between the first and second areas A1 and A2 is shifted and the first duration is extended for the usual driving criterion. FIG. 6 shows the vehicle 1 with the right-hand steering wheel as viewed from above. The radial solid lines indicate the imaginary areas A1, A2, and A3. The broken line indicates the centerline in the width direction of the vehicle 1. The dot-and-dash line indicates the straight traveling direction of the vehicle 1. The two-dot chain line indicates the boundary position between the first and second areas A1 and A2 under the usual driving criterion. The left direction indicator 7C is blinking.

The left criterion will be described below with reference to FIG. 6. The left criterion described below is a mere example, and may be any criterion for the left of the vehicle 1 changed from the usual driving criterion. In this example, the distracted driving determination apparatus 2 increases the first angle θ1 of the first area A1 and decreases the second angle θ2 of the second area A2 without shifting the boundary between the first and third areas A1 and A3 and the end of the second area A2 opposite to the boundary between the first and second areas A1 and A2. Thus, the distracted driving determination apparatus 2 shifts the boundary between the first and second areas A1 and A2.

The first area A1 and the second area A2 will be described first.

The first area A1 and the second area A2 together are at the same positions and in the same ranges as under the usual driving criterion. The boundary position between the first and second areas A1 and A2 differs from the position under the usual driving criterion. The boundary position between the first and second areas A1 and A2 corresponds to the boundary position between the sub-areas A21 and A22 under the usual driving criterion. In other words, the boundary between the first and second areas A1 and A2 is at a position shifted counterclockwise as viewed from the driver from the boundary position under the usual driving criterion. Thus, the directions relative to the driver under the left criterion differ from those under the usual driving criterion.

The first angle θ1 of the first area A1 is greater than the angle under the usual driving criterion. Thus, the range of the first area A1 under the left criterion is enlarged to the left of the vehicle 1 more than the range of the first area A1 under the usual driving criterion.

The end of the second area A2, which is located opposite to the boundary between the first and second areas A1 and A2, is at the same position as under the usual driving criterion. The second angle θ2 of the second area A2 is smaller than the angle under the usual driving criterion, and is the same as the fifth angle θ5 of the sub-area A22 under the usual driving criterion. The position of the second area A2 corresponds to the position of the sub-area A22 under the usual driving criterion. Thus, the range of the second area A2 under the left criterion is reduced from the range of the second area A2 under the usual driving criterion.

The length of the first duration will now be described.

The allowable duration T2 (e.g., 5 seconds) associated with the second area A2 under the left criterion is longer than the allowable duration T22 (3 seconds) associated with the sub-area A22 under the usual driving criterion. Thus, the allowable duration under the left criterion is changed from the duration under the usual driving criterion.

When the process for shifting the boundary between the first and second areas A1 and A2 is eliminated, the allowable duration T21 associated with the sub-area A21 under the left criterion is longer than that under the usual driving criterion. Similarly, the allowable duration T22 associated with the sub-area A22 under the left criterion is longer than that under the usual driving criterion. Under the left criterion, the allowable duration T21 associated with the sub-area A21 may or may not be the same as the allowable duration T22 associated with the sub-area A22.

The process for extending the first duration may be eliminated when the process for shifting the boundary between the first and second areas A1 and A2 is performed.

The third area A3 will now be described.

The boundary between the first and third areas A1 and A3 is at the same position as under the usual driving criterion. The end of the third area A3, which is located opposite to the boundary between the first and third areas A1 and A3, is at the same position as under the usual driving criterion. The third angle θ3 of the third area A3 is the same as the angle under the usual driving criterion. Thus, the position and the range of the third area A3 are the same as those under the usual driving criterion. The sixth angle θ6 of the sub-area A31 is the same as the angle under the usual driving criterion. Thus, the position and the range of the sub-area A31 are the same as those under the usual driving criterion. The length of the allowable duration T31 associated with the sub-area A31 is the same as the length under the usual driving criterion. The seventh angle θ7 of the sub-area A32 is the same as the angle under the usual driving criterion. Thus, the position and the range of the sub-area A32 are the same as those under the usual driving criterion. The length of the allowable duration T32 associated with the sub-area A32 is the same as the length under the usual driving criterion.

Thus, the positions and the ranges of the third area A3, the sub-area A31, and the sub-area A32, and the allowable duration T31 associated with the sub-area A31 and the allowable duration T32 associated with the sub-area A32 are the same for the left criterion and the usual driving criterion. This is because the driver is unlikely to look to the right of the vehicle 1 during the operation of the left direction indicator 7C, and thus the distracted driving determination criterion defined for the right of the vehicle 1 may not be changed.

The left criterion may be defined as described below.

The boundary position between the first and second areas A1 and A2 may differ between the right-hand steering wheel and the left-hand steering wheel. The first duration may differ between the right-hand steering wheel and the left-hand steering wheel. The boundary position between the first and second areas A1 and A2 may differ from the boundary position between the sub-areas A21 and A22 under the usual driving criterion. The second angle θ2 of the second area A2 may be greater than the fifth angle θ5 of the sub-area A22 under the usual driving criterion. The end of the second area A2, which is located opposite to the boundary between the first and second areas A1 and A2, may be shifted counterclockwise as viewed from the driver from the boundary position under the usual driving criterion when the boundary position between the first and second areas A1 and A2 is shifted. The boundary position between the first and third areas A1 and A3 may differ from the position under the usual driving criterion. The third angle θ3 of the third area A3 may differ from the angle under the usual driving criterion. The sixth angle θ6 of the sub-area A31 and the seventh angle θ7 of the sub-area A32 may differ from those under the usual driving criterion. The length of the allowable duration T31 associated with the sub-area A31 may differ from the length under the usual driving criterion. The length of the allowable duration T32 associated with the sub-area A32 may differ from the length under the usual driving criterion. The allowable duration T31 associated with the sub-area A31 may be the same as the allowable duration T32 associated with the sub-area A32.

### Right Criterion

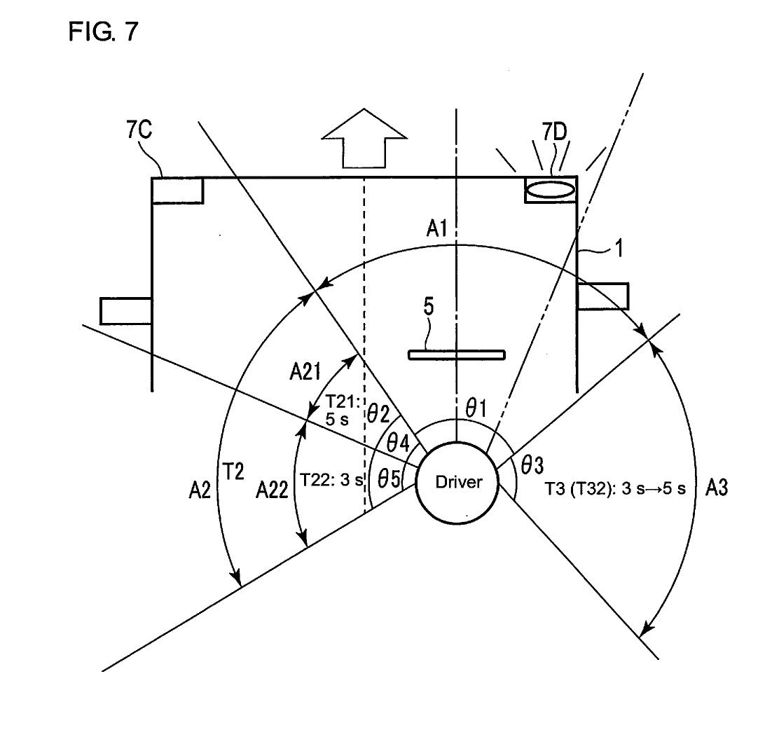

FIG. 7 is a schematic diagram describing the right criterion resulting from the second change process for the usual driving criterion. In the example shown in FIG. 7, the boundary between the first and third areas A1 and A3 is shifted and the second duration is extended for the usual driving criterion. FIG. 7 shows the vehicle 1 with the right-hand steering wheel as viewed from above. The radial solid lines indicate the imaginary areas A1, A2, and A3. The broken line indicates the centerline in the width direction of the vehicle 1. The dot-and-dash line indicates the straight traveling direction of the vehicle 1. The two-dot chain line indicates the boundary position between the first and third areas A1 and A3 under the usual driving criterion. The right direction indicator 7D is blinking.

The right criterion will be described below with reference to FIG. 7. The right criterion described below is a mere example, and may be any criterion for the right of the vehicle 1 changed from the usual driving criterion. In this example, the distracted driving determination apparatus 2 increases the first angle θ1 of the first area A1 and decreases the third angle θ3 of the third area A3 without shifting the boundary between the first and second areas A1 and A2 and the end of the third area A3 opposite to the boundary between the first and third areas A1 and A3. Thus, the distracted driving determination apparatus 2 shifts the boundary between the first and third areas A1 and A3.

The first area A1 and the third area A3 will be described first.

The first area A1 and the third area A3 together are at the same positions and in the same ranges as under the usual driving criterion. The boundary position between the first and third areas A1 and A3 differs from the position under the usual driving criterion. The boundary position between the first and third areas A1 and A3 corresponds to the boundary position between the sub-areas A31 and A32 under the usual driving criterion. In other words, the boundary between the first and third areas A1 and A3 is at a position rotated clockwise as viewed from the driver from the boundary position under the usual driving criterion. Thus, the directions relative to the driver under the right criterion is changed from those under the usual driving criterion.

The first angle θ1 of the first area A1 is greater than the angle under the usual driving criterion. Thus, the range of the first area A1 under the right criterion is enlarged to the right of the vehicle 1 more than the range of the first area A1 under the usual driving criterion.

The end of the third area A3, which is located opposite to the boundary between the first and third areas A1 and A3, is at the same position as under the usual driving criterion. The third angle θ3 of the third area A3 is smaller than the angle under the usual driving criterion, and is the same as the angle θ7 of the sub-area A32 under the usual driving criterion. The position of the third area A3 corresponds to the position of the sub-area A32 under the usual driving criterion. Thus, the range of the third area A3 under the right criterion is reduced from the range of the third area A3 under the usual driving criterion.

The length of the second duration will now be described.

The allowable duration T3 (e.g., 5 seconds) associated with the third area A3 under the right criterion is longer than the allowable duration T32 (3 seconds) associated with the sub-area A32 under the usual driving criterion. Thus, the allowable duration under the right criterion is changed from the duration under the usual driving criterion.

When the process for shifting the boundary between the first and third areas A1 and A3 is eliminated, the allowable duration T31 associated with the sub-area A31 under the right criterion is longer than the duration under the usual driving criterion. Similarly, the allowable duration T32 associated with the sub-area A32 under the right criterion is longer than the duration under the usual driving criterion. Under the right criterion, the allowable duration T31 associated with the sub-area A31 may or may not be the same as the allowable duration T32 associated with the sub-area A32.

The process for extending the second duration may be eliminated when the process for shifting the boundary between the first and third areas A1 and A3 is performed.

The second area A2 will now be described.

The boundary position between the first and second areas A1 and A2 is at the same position as under the usual driving criterion. The end of the second area A2, which is located opposite to the boundary between the first and second areas A1 and A2, is at the same position as under the usual driving criterion. The second angle θ2 of the second area A2 is the same as the angle under the usual driving criterion. Thus, the position and the range of the second area A2 are the same as those under the usual driving criterion. The fourth angle θ4 of the sub-area A21 is the same as the angle under the usual driving criterion. Thus, the position and the range of the sub-area A21 are the same as those under the usual driving criterion. The length of the allowable duration T21 associated with the sub-area A21 is the same as the length under the usual driving criterion. The fifth angle θ5 of the sub-area A22 is the same as the angle under the usual driving criterion. Thus, the position and the range of the sub-area A22 are the same as those under the usual driving criterion. The length of the allowable duration T22 associated with the sub-area A22 is the same as the length under the usual driving criterion.

Thus, the positions and the ranges of the second area A2, the sub-area A21, and the sub-area A22, and the allowable duration T21 associated with the sub-area A21 and the allowable duration T22 associated with the sub-area A22 are the same for the right criterion and the usual driving criterion. This is because the driver is unlikely to look to the left of the vehicle 1 during the operation of the right direction indicator 7D, and thus the distracted driving determination criterion defined for the left of the vehicle 1 may not be changed.

The right criterion may be defined as described below.

The boundary position between the first and third areas A1 and A3 may differ between the right-hand steering wheel and the left-hand steering wheel. The length of the second duration may differ between the right-hand steering wheel and the left-hand steering wheel. The deviation (angle) of the boundary between the first and third areas A1 and A3 under the right criterion from the straight traveling direction of the vehicle 1 may or may not have the same absolute value as the deviation (angle) of the boundary between the first and second areas A1 and A2 under the left criterion from the straight traveling direction of the vehicle 1. The length of the second duration under the right criterion may or may not be the same as the length of the first duration under the left criterion. The boundary position between the first and third areas A1 and A3 may differ from the boundary position between the sub-areas A31 and A32 under the usual driving criterion. The third angle θ3 of the third area A3 may be greater than the seventh angle θ7 of the sub-area A32 under the usual driving criterion. The end of the third area A3, which is located opposite to the boundary between the first and third areas A1 and A3, may be shifted clockwise as viewed from the driver from the boundary position under the usual driving criterion when the boundary position between the first and third areas A1 and A3 is shifted. The boundary position between the first and second areas A1 and A2 may differ from the position under the usual driving criterion. The second angle θ2 of the second area A2 may differ from the angle under the usual driving criterion. The fourth angle θ4 of the sub-area A21 and the fifth angle 95 of the sub-area A22 may differ from those under the usual driving criterion. The length of the allowable duration T21 associated with the sub-area A21 may differ from the length under the usual driving criterion. The length of the allowable duration T22 associated with the sub-area A22 may differ from the length under the usual driving criterion. The allowable duration T21 associated with the sub-area A21 may be the same as the allowable duration T22 associated with the sub-area A22.

### 3. OPERATION EXAMPLES

### Distracted Driving Determination Apparatus

### Operation for Determining Distracted Driving

The operation for determining distracted driving performed by the distracted driving determination apparatus 2 will now be described.

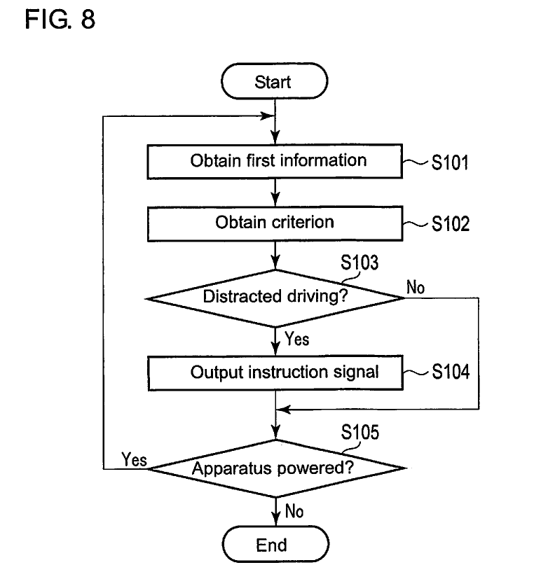

FIG. 8 is a flowchart showing distracted driving determination performed by the distracted driving determination apparatus 2. The procedure described below is a mere example, and each of its processes may be modified. In the procedure described below, steps may be eliminated, substituted, or added as appropriate.

As described above, the first obtaining unit 2101 obtains the first information indicating the gaze or face orientation of the driver (step S101).

As described above, the determiner 2102 obtains the criterion (step S102).

As described above, the determiner 2102 determines distracted driving by comparing the gaze or face orientation indicated by the first information with the criterion to (step S103). When the determiner 2102 determines that the driver is engaging in distracted driving (Yes in step S103), the output unit 2106 outputs an instruction signal (step S104) as described above.

The control unit 21 determines whether the distracted driving determination apparatus 2 is powered (step S105). When the distracted driving determination apparatus 2 is powered (Yes in step S105), the control unit 21 repeats the processing in step S101 and subsequent steps. The control unit 21 ends the distracted driving determination when the power supply to the distracted driving determination apparatus 2 is stopped (No in step S105).

Returning to step S103, when determining that the driver is not engaging in distracted driving (No in step S103), the control unit 21 performs the processing in step S105 as described above.

### Example of Criterion Change Operation

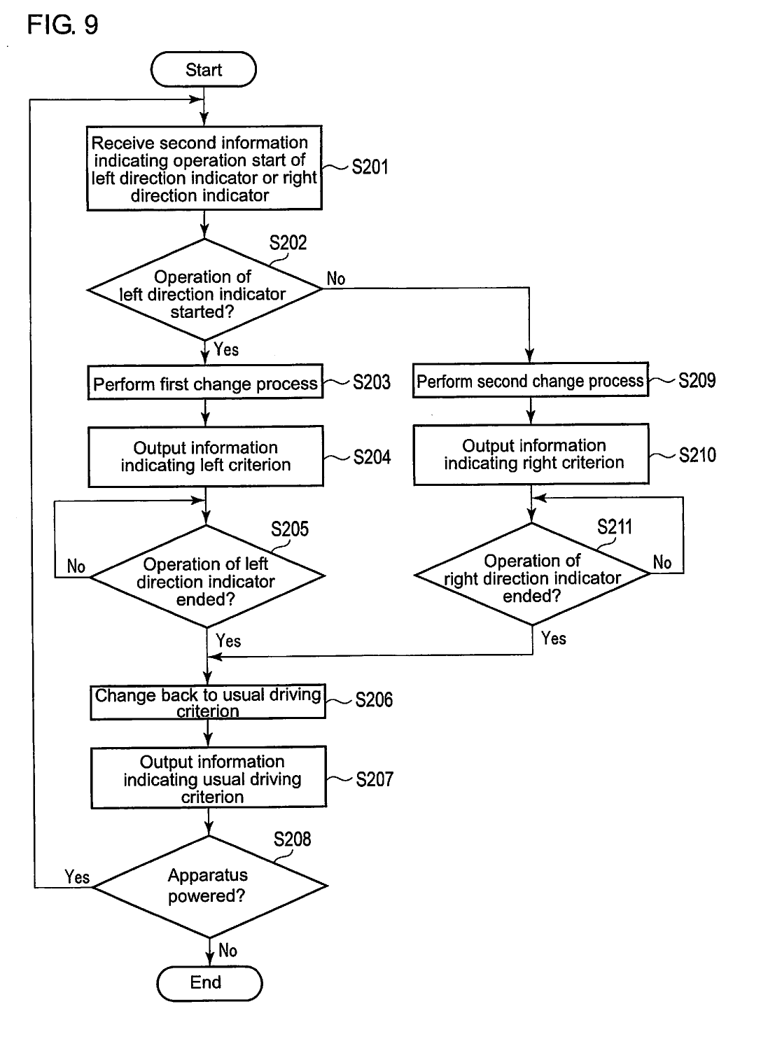

FIG. 9 is a flowchart showing an example operation for changing the criterion performed by the distracted driving determination apparatus 2. The procedure described below is a mere example, and each of its processes may be modified. In the procedure described below, steps may be eliminated, substituted, or added as appropriate.

The criterion changer 2105 receives the second information (step S201) indicating an operation start of the left direction indicator 7C or the right direction indicator 7D.

The criterion changer 2105 determines whether an operation start of the left direction indicator 7C has been detected (step S202) based on the second information.

The criterion changer 2105 that has detected an operation start of the left direction indicator 7C (Yes in step S202) performs the first change process for the usual driving criterion (step S203). The criterion changer 2105 determines to use the left criterion, and outputs information indicating the left criterion to the determiner 2102 (step S204).

The criterion changer 2105 determines whether an operation end of the left direction indicator 7C has been detected (step S205). The criterion changer 2105 that has not detected an operation end of the left direction indicator 7C (No in step S205) continues the processing in step S205.

The criterion changer 2105 that has detected an operation end of the left direction indicator 7C (Yes in step S205) changes the criterion from the left criterion back to the usual driving criterion (step S206). The criterion changer 2105 determines to use the usual driving criterion, and outputs information indicating the usual driving criterion to the determiner 2102 (step S207).

The criterion changer 2105 determines whether the distracted driving determination apparatus 2 is powered (step S208). When the distracted driving determination apparatus 2 is powered (Yes in step S208), the criterion changer 2105 repeats the processing in step S201 and subsequent steps. The criterion changer 2105 ends the distracted driving determination when the power supply to the distracted driving determination apparatus 2 is stopped (No in step S208).

Returning to step S202, the criterion changer 2105 that has not detected an operation start of the left direction indicator 7C (No in step S202) determines that the right direction indicator 7D has started operating. The criterion changer 2105 performs the second change process for the usual driving criterion (step S209). The criterion changer 2105 determines to use the right criterion, and outputs information indicating the right criterion to the determiner 2102 (step S210).

The criterion changer 2105 determines whether an operation end of the right direction indicator 7D has been detected (step S211). The criterion changer 2105 that has not detected an operation end of the right direction indicator 7D (No in step S211) continues the processing in step S211.

The criterion changer 2105 that has detected an operation end of the right direction indicator 7D (Yes in step S211) changes the criterion from the right criterion back to the usual driving criterion (step S206). The criterion changer 2105 performs the processing in steps S207 and S208 as described above.

With the criterion changing operation performed by the criterion changer 2105 described above, the determiner 2102 can determine whether the driver is engaging in distracted driving using various determination criteria as described below. The determiner 2102 determines whether the driver is engaging in distracted driving using the usual driving criterion while the left direction indicator 7C and the right direction indicator 7D are not operating. The determiner 2102 determines whether the driver is engaging in distracted driving using the left criterion during the operation of the left direction indicator 7C. The determiner 2102 determines whether the driver is engaging in distracted driving using the right criterion during the operation of the right direction indicator 7D.

### Another Example of Criterion Changing Operation

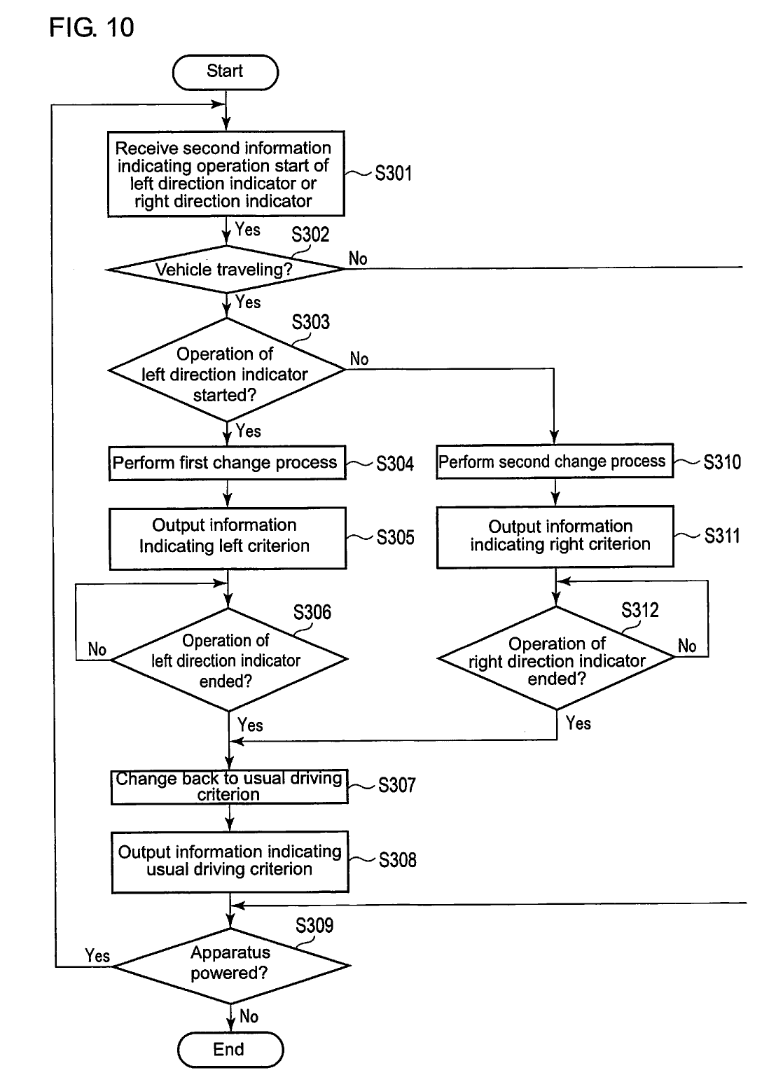

FIG. 10 is a flowchart showing another example operation for changing the criterion performed by the distracted driving determination apparatus 2. The procedure described below is a mere example, and each of its processes may be modified. In the procedure described below, steps may be eliminated, substituted, or added as appropriate.

The criterion changer 2105 receives the second information indicating an operation start of the left direction indicator 7C or the right direction indicator 7D (step S301).

As described above, the criterion changer 2105 determines whether the vehicle 1 is traveling (step S302).

When the vehicle 1 is traveling (Yes in step S302), the criterion changer 2105 performs the processing in steps S303 through S312. The processing in steps S303 through S312 is the same as the processing in steps S202 through S211 shown in FIG. 9, and will not be described.

When the vehicle 1 is not traveling (No in step S302), the criterion changer 2105 determines that the vehicle 1 is stopped, and performs the processing in step S309.

With the criterion changing operation performed by the criterion changer 2105 described above, the determiner 2102 can determine whether the driver is engaging in distracted driving using various determination criteria as described below. The determiner 2102 determines whether the driver is engaging in distracted driving using the usual driving criterion while the left direction indicator 7C and the right direction indicator 7D are not operating. The determiner 2102 determines whether the driver is engaging in distracted driving using the left criterion when the vehicle 1 is traveling and the left direction indicator 7C is operating. The determiner 2102 determines whether the driver is engaging in distracted driving using the right criterion when the vehicle 1 is traveling and the right direction indicator 7D is operating.

The determiner 2102 does not use the left criterion during the operation of the left direction indicator 7C while the vehicle 1 is stopped. The determiner 2102 may use the usual driving criterion or another criterion for the stopped vehicle 1 different from the usual driving criterion. Similarly, the determiner 2102 does not use the right criterion during the operation of the right direction indicator 7D while the vehicle 1 is stopped. The determiner 2102 may use the usual driving criterion or the criterion for the stopped vehicle 1.

### Support Apparatus

### Support Operation for Driver

A support operation for the driver performed by the navigation apparatus 12, which is an example of the support apparatus, will be described first. The navigation apparatus 12 receives an instruction signal from the distracted driving determination apparatus 2. In response to the instruction signal, the navigation apparatus 12 displays an alert for the driver about distracted driving using an image or a video on the display 121.

A support operation for the driver performed by the sound output apparatus 13, which is an example of the support apparatus, will now be described. The sound output apparatus 13 receives an instruction signal from the distracted driving determination apparatus 2. In response to the instruction signal, the sound output apparatus 13 outputs an alert for the driver about distracted driving using a sound from the speaker 131. An alert may be in any form that can notify the driver of his or her distracted driving or of the need to look at the front of the vehicle 1.

The driver receives the support operation from the support apparatus. This allows the driver to notice his or her distracted driving and refocus on driving the vehicle 1.

### 4. ADVANTAGES AND EFFECTS

In the present embodiment described above, the distracted driving determination apparatus 2 determines distracted driving of the driver by comparing the gaze or face orientation of the driver with the criterion varying depending on the operational state of each direction indicator indicated by the second information.

As described below, the distracted driving determination apparatus 2 thus improves the accuracy of distracted driving determination performed when the vehicle 1 changes the traveling direction. For example, when the driver intends to operate the direction indicators when turning right or left, changing the lane, or pulling over to the side of a road, the driver tends to intentionally direct his or her gaze or face in a direction different from the straight traveling direction. The distracted driving determination apparatus 2 lowers the likelihood that such actions of the driver are erroneously determined to be distracted driving, and thus improves the accuracy of distracted driving determination.

In the present embodiment, the distracted driving determination apparatus 2 further changes the criterion during the operation of each direction indicator.

Thus, the distracted driving determination apparatus 2 improves the accuracy of distracted driving determination during the operation of each direction indicator as descried below. For example, the driver is likely to intentionally direct his or her gaze or face in a direction different from the straight traveling direction during the operation of each direction indicator. The distracted driving determination apparatus 2 changes the criterion to lower the likelihood that such actions of the driver are erroneously determined to be distracted driving, and thus improves the accuracy of distracted driving determination.

In the present embodiment, the distracted driving determination apparatus 2 further changes the criterion for the left of the vehicle 1 during the operation of the left direction indicator 7C, and changes the criterion for the right of the vehicle 1 during the operation of the right direction indicator 7D.

Thus, the distracted driving determination apparatus 2 improves the accuracy of distracted driving determination during the operation of the left direction indicator 7C or the right direction indicator 7D as descried below. For example, the driver is likely to intentionally direct his or her gaze or face in the direction indicated by the direction indicator operated intentionally by the driver. The distracted driving determination apparatus 2 lowers the likelihood that such actions of the driver are determined to be distracted driving, and thus improves the accuracy of distracted driving determination during the operation of the left direction indicator 7C or the right direction indicator 7D.

In the present embodiment, the distracted driving determination apparatus 2 further determines that the driver is not engaging in distracted driving when his or her gaze or face orientation is within the first area A1. The distracted driving determination apparatus 2 determines that the driver is engaging in distracted driving when his or her gaze or face orientation resides within the second area A2 for a duration longer than the first duration or the third area A3 for a duration longer than the second duration.

Thus, the distracted driving determination apparatus 2 defines imaginary areas in the front, right, and left of the vehicle 1 relative to the position of the driver to determine distracted driving of the driver, and thus improves the accuracy of distracted driving determination.

In the present embodiment, the distracted driving determination apparatus 2 further shifts the boundary between the first and second areas A1 and A2 in response to an operation start of the left direction indicator 7C or shifts the boundary between the first and third areas A1 and A3 in response to an operation start of the right direction indicator 7D.

As described below, the distracted driving determination apparatus 2 thus improves the accuracy of distracted driving determination during the operation of the left direction indicator 7C or the right direction indicator 7D by shifting the boundaries between the areas. For example, the driver is likely to intentionally direct his or her gaze or face in the direction indicated by the direction indicator operated intentionally by the driver. The distracted driving determination apparatus 2 improves the accuracy of distracted driving determination by evaluating the gaze or face orientation of the driver using the criterion under which the boundaries between the areas have been shifted during the operation of the left direction indicator 7C or the right direction indicator 7D.

In the present embodiment, the distracted driving determination apparatus 2 further extends the first duration in response to an operation start of the left direction indicator 7C or extends the second duration in response to an operation start of the right direction indicator 7D.

As described below, the distracted driving determination apparatus 2 thus improves the accuracy of distracted driving determination by increasing the allowable durations during the operation of the left direction indicator 7C or the right direction indicator 7D. For example, the driver is likely to intentionally direct his or her gaze or face in the direction indicated by the direction indicator operated intentionally by the driver. The distracted driving determination apparatus 2 improves the accuracy of distracted driving determination by evaluating the gaze or face orientation of the driver using the criterion under which the allowable durations have been extended during the operation of the left direction indicator 7C or the right direction indicator 7D.

In the present embodiment, the distracted driving determination apparatus 2 further disables the change of the criterion while the vehicle 1 is stopped.

As described below, the distracted driving determination apparatus 2 thus correctly determines whether the driver is engaging in distracted driving during the operation of the left direction indicator 7C or the right direction indicator 7D while the vehicle 1 is stopped. For example, while the vehicle 1 is stopped to wait for, for example, pedestrians to cross the road or for a traffic signal to change, the driver may direct his or her gaze or face forward rather than rightward or leftward from the vehicle 1 during the operation of the left direction indicator 7C or the right direction indicator 7D. Under such situations, the distracted driving determination apparatus 2 can correctly determine whether the driver is engaging in distracted driving by disabling the change of the criterion for the left or the right of the vehicle 1.

In the present embodiment, the driving support system further supports the driver based on the determination result indicating that the driver is engaging in distracted driving.

Thus, the driving support system provides support including an alert for the driver when detecting his or her distracted driving. This allows the driver to notice his or her distracted driving and refocus on driving.

### 5. MODIFICATIONS

### 5-1. Modification 1

Although the criterion changer 2105 changes the criterion for the direction in which the direction indicator is operating in the above present embodiment, the embodiment is not limited to this structure.

The criterion changer 2105 may change the criterion for a direction opposite to the direction in which the direction indicator is operating. For example, the criterion changer 2105 may perform the second change process for the usual driving criterion to change the criterion for the right of the vehicle 1 during the operation of the left direction indicator 7C. Thus, the determiner 2102 may use the above right criterion to determine distracted driving of the driver during the operation of the left direction indicator 7C. The criterion changer 2105 may perform the first change process for the usual driving criterion to change the criterion for the left of the vehicle 1 during the operation of the right direction indicator 7D. Thus, the determiner 2102 may use the above left criterion to determine distracted driving of the driver during the operation of the right direction indicator 7D.

The criterion changer 2105 may change the criterion for both the direction in which the direction indicator is operating and its opposite direction. For example, the criterion changer 2105 may perform the first change process and the second change process for the usual driving criterion to change the criterion for the right and the left of the vehicle 1 during the operation of the left direction indicator 7C. Thus, the determiner 2102 may use the usual driving criterion resulting from the first change process and the second change process to determine distracted driving of the driver during the operation of the left direction indicator 7C. The criterion changer 2105 may perform the first change process and the second change process to change the criterion for the left and the right of the vehicle 1 during the operation of the right direction indicator 7D. Thus, the determiner 2102 may use the usual driving criterion resulting from the first change process and the second change process to determine distracted driving of the driver during the operation of the right direction indicator 7D.

The driver may direct his or her gaze or face not only in the direction in which the direction indicator is operating but also in the direction opposite to the direction in which the direction indicator is operating. The distracted driving determination apparatus 2 changes the criterion for at least the direction opposite to the direction in which the direction indicator is operating, and thus can improve the accuracy of distracted driving determination performed when the vehicle 1 changes the traveling direction.

### 5-2. Modification 2

Although the criterion for the left of the vehicle 1 is changed during the operation of the left direction indicator 7C, and the criterion for the right of the vehicle 1 is changed during the operation of the right direction indicator 7D in the above present embodiment, the embodiment is not limited to this structure. The distracted driving determination apparatus 2 may change the criterion for the left of the vehicle 1 during the operation of the left direction indicator 7C, but may not change the criterion for the right of the vehicle 1 during the operation of the right direction indicator 7D. For example, the distracted driving determination apparatus 2 may perform the first change process during the operation of the left direction indicator 7C, but may not perform the second change process during the operation of the right direction indicator 7D. Conversely, the distracted driving determination apparatus 2 may change the criterion for the right of the vehicle 1 during the operation of the right direction indicator 7D, but may not change the criterion for the left of the vehicle 1 during the operation of the left direction indicator 7C. For example, the distracted driving determination apparatus 2 may perform the second change process during the operation of the right direction indicator 7D, but may not perform the first change process during the operation of the left direction indicator 7C.

### 5-3. Modification 3

The present invention is not limited to the present embodiment, but the components may be modified without departing from the spirit and scope of the invention. The components described in the present embodiment may be combined as appropriate to provide various aspects of the invention. For example, some of the components described in the present embodiment may be eliminated. Further, components in different embodiments may be combined as appropriate.

### 6. APPENDIX

The present embodiment may be partially or entirely expressed in, but not limited to, the following forms shown in the appendix below in addition to the claims.

### APPENDIX

A distracted driving determination apparatus (2), comprising:

a first obtaining unit (2101) configured to obtain first information indicating a gaze or a face orientation of a driver;

a second obtaining unit (2103) configured to obtain second information indicating an operational state of a direction indicator; and

a determiner (2102) configured to determine distracted driving by comparing the gaze or the face orientation indicated by the first information with a predetermined criterion indicating a direction or a duration that varies depending on the operational state indicated by the second information.

1. A distracted driving determination apparatus, comprising:
a first obtaining unit configured to obtain first information indicating a gaze or a face orientation of a driver;
a second obtaining unit configured to obtain second information indicating an operational state of a direction indicator; and
a determiner configured to determine distracted driving by comparing the gaze or the face orientation indicated by the first information with a predetermined criterion indicating a direction or a duration that varies depending on the operational state indicated by the second information.

2. The distracted driving determination apparatus according to claim 1, further comprising:
a criterion changer configured to change the predetermined criterion based on the second information during an operation of the direction indicator.

3. The distracted driving determination apparatus according to claim 2, wherein
the direction indicator includes a right direction indicator and a left direction indicator, and
the criterion changer changes the predetermined criterion for a left of a vehicle during an operation of the left direction indicator and changes the predetermined criterion for a right of the vehicle during an operation of the right direction indicator.

4. The distracted driving determination apparatus according to claim 3, wherein
the determiner determines that the driver is not engaging in distracted driving when the gaze or the face orientation of the driver is within a first area that is an imaginary area ranging from the driver toward a front of the vehicle, and
determines that the driver is engaging in distracted driving when the gaze or the face orientation is within a second area that is an imaginary area adjacent to the first area and ranging from the driver toward a left of the vehicle for a duration longer than a first duration or within a third area that is an imaginary area adjacent to the first area and ranging from the driver toward a right of the vehicle for a duration longer than a second duration.

5. The distracted driving determination apparatus according to claim 4, wherein
the criterion changer shifts, in response to an operation start of the left direction indicator, a boundary between the first area and the second area counterclockwise as viewed from the driver from a boundary position used when the left direction indicator and the right direction indicator are not operating, or shifts, in response to an operation start of the right direction indicator, a boundary between the first area and the third area clockwise as viewed from the driver from a boundary position used when the left direction indicator and the right direction indicator are not operating.

6. The distracted driving determination apparatus according to claim 4, wherein
the criterion changer extends the first duration in response to an operation start of the left direction indicator or extends the second duration in response to an operation start of the right direction indicator.

7. The distracted driving determination apparatus according to claim 3, further comprising:
a third obtaining unit configured to obtain third information indicating a traveling state of the vehicle, wherein
the criterion changer changes the predetermined criterion in response to an operation start of the left direction indicator or changes the predetermined criterion in response to an operation start of the right direction indicator during traveling of the vehicle, and disables a change of the predetermined criterion while the vehicle is stopped.

8. A driving support system, comprising:
the distracted driving determination apparatus according to claim 1, the apparatus further comprising an output unit configured to output an instruction signal for supporting the driver based on a determination result indicating that the driver is engaging in distracted driving; and
a support apparatus configured to support the driver in response to the instruction signal.

9. A distracted driving determination method, comprising:
obtaining first information indicating a gaze or a face orientation of a driver;
obtaining second information indicating an operational state of a direction indicator; and
detecting distracted driving by comparing the gaze or the face orientation indicated by the first information with a predetermined criterion indicating a direction or a duration that varies depending on the operational state indicated by the second information.

10. A non-transitory computer-readable medium storing a program for determining distracted driving, the program causing a computer to implement processes performed by the units included in the distracted driving determination apparatus according to claim 1.
